(19) United States
(12) Patent Application Publication
(10) Pub. No.: US 2023/0412785 A1
(43) Pub. Date: Dec. 21, 2023

(54) GENERATING PARALLAX EFFECT BASED ON VIEWER POSITION

(71) Applicant: Microsoft Technology Licensing, LLC, Redmond, WA (US)

(72) Inventors: Karim Henrik BENCHEMSI, Kirkland, WA (US); Aleksandar UZELAC, Seattle, WA (US); Ilya Dmitriyevich ZHARKOV, Sammamish, WA (US)

(21) Appl. No.: 17/843,545

(22) Filed: Jun. 17, 2022

(51) Int. Cl. H04N 13/128; H04N 13/302; G06T 7/194; G06T 7/70; G06V 40/16

(52) U.S. Cl. CPC H04N 13/128; H04N 13/302; G06T 2207/30201; G06T 7/70; G06V 40/161; G06T 7/194

(57) ABSTRACT

Technologies disclosed herein relate to construction of a composite image to provide a parallax effect. An image is generated, and a first computer-readable image and a second computer-readable image are generated based upon the image. The first computer-readable image represents foreground of a scene and the second computer-readable image represents background of a scene. A location of eyes of a viewer relative to a display is determined, and the first computer-readable image is overlaid upon the second computer-readable image at a position that is based upon the location of the eyes of the viewer.

### BACKGROUND

Video conferencing technology plays an important role in maintaining working and personal relationships between people who are physically distant from each other. In a typical videoconferencing scenario, a first user employs a first computing device and a second user employs a second computing device, where video captured by the first computing device is transmitted to the second computing device and video captured by the second computing device is transmitted to the first computing device. Accordingly, the first user and the second user can have a “face to face” conversation by way of the first and second computing devices.

Conventional computing systems and video conferencing applications, however, are unable to provide users with immersive experiences when the users are participating in video conferences, which is at least partially due to equipment of computing devices typically employed in video conferencing scenarios. Computing devices typically employed in connection with videoconferencing applications include relatively inexpensive two-dimensional (2D) cameras and planar display screens; accordingly, for example, a display of the first computing device displays a 2D video on a 2D display, such that the video fails to exhibit depth characteristics. Therefore, despite continuous improvements in the resolution and visual quality of the images generated by cameras used for video conferencing, the presentation of the image on a flat two-dimensional screen lacks the depth and other immersive characteristics that are perceived by the viewer when meeting in person.

### SUMMARY

The following is a brief summary of subject matter that is described in greater detail herein. This summary is not intended to be limiting as to the scope of the claims.

Described herein are technologies relating to creating composite images to provide a parallax effect to a viewer. An image is captured; for example, the image can include a face of a first videoconference participant and background imagery. A computing system processes the image to create a foreground image and a background image. Continuing with the example above, the foreground image includes the face of the first videoconference participant and the background image includes the background imagery.

With more specificity, the computing system extracts the foreground from the image, leaving a void in the image. The computing system populates the with pixel values to create the background image, where any suitable technology can be employed to populate the void with pixel values. Optionally, the computing system can blur the background image to smooth the transition between the populated void and the remaining background image.

The computing system generates a composite image based upon the (blurred) background image, the foreground image, and location data that is indicative of location of the eyes of the viewer relative to a display being viewed by the viewer. More specifically, when generating the composite image, the computing system overlays the foreground image upon the background image, with position of the foreground image relative to the background image being based upon the location data. Thus, the foreground image is at a first position relative to the background image when the head of the viewer is at a first location relative to the display, while the foreground image is at a second position relative to the background image when the head of the viewer is at a second location relative to the display.

The technologies described herein are particularly well-suited for use in a videoconferencing scenario, where the computing system generates immersive imagery during a videoconference. The computing system continuously generates composite imagery during the videoconference, such that a parallax effect is presented during the videoconference.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a schematic that illustrates display of a composite image when eyes of a user are at a first position relative to a display, where a background object is partially obscured by a foreground object in the composite image.

FIG. 2 is a schematic that illustrates display of a second composite image when eyes of the user are at a second position relative to the display, where the background object is no longer obscured by the foreground object in the composite image due to the eyes of the user being at the second position relative to the display (e.g., the user has moved his or her head to the right relative to the display, causing the background object to no longer be obscured by the foregoing object).

FIG. 3 is a functional block diagram of a computing system that is configured to generate a composite image.

FIG. 4 is a functional block diagram of a composite image generator system that receives an image having a foreground object and background, wherein the composite image generator system positions the foreground relative to the background based upon position of eyes of a viewer.

FIG. 5 is a schematic that illustrates operation of a foreground extractor module.

FIGS. 6 and 7 are schematics that illustrate operation of a background constructor module.

FIG. 8 is a schematic that illustrates operation of a positioner module.

FIG. 9 is a functional block diagram of a computing environment where two client computing devices are used in a videoconferencing scenario.

FIGS. 10 and 11 are flow diagrams illustrating methodologies for creating composite images.

FIG. 12 is an example computing system.

### DETAILED DESCRIPTION

Various technologies pertaining generally to constructing composite images, and more particularly to constructing composite images in the context of a video conferencing environment, are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component,” “system,” and module are intended to encompass computer-readable data storage that is configured with computer-executable instructions that cause certain functionality to be performed when executed by a processor. The computer-executable instructions may include a routine, a function, or the like. It is also to be understood that a component, system, or module may be localized on a single device or distributed across several devices. Further, as used herein, the term “exemplary” is intended to mean serving as an illustration or example of something and is not intended to indicate a preference.

When meeting in-person, the depth of various features of the environment relative to the viewer contributes to the sense of being present with the other person or people. The depth of the environmental features of a room, for example, are estimated based on the images received by each eye of the viewer. Another clue to the relationship between objects in 3D-space is parallax—e.g., the relative displacement or movement of those objects in the field of view of the viewer as the viewer moves their head from one location to another location. Presenting a pseudo-3D or 2.5D video generated from a received 2D video can simulate the parallax effect viewed when meeting in person. The generated video that includes a simulated parallax effect provides the viewer with an experience that is more immersive than viewing a flat, 2D video. Generating video that simulates the parallax experienced during an in-person conversation or meeting provides a subtle but significant improvement in the feeling of presence during a video call.

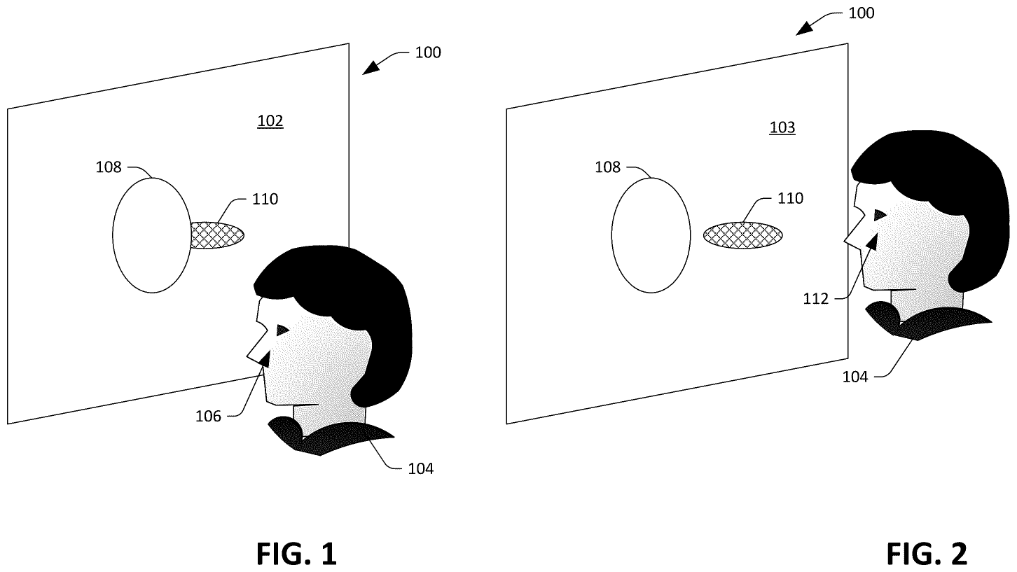

Referring now to FIG. 1, a schematic view of a display 100 is shown, where an exemplary first composite image 102 is displayed on the display 100 when a user 104 is at a first position. As will be described in greater detail herein, a computing system (not shown) receives an (2D) image and identifies a foreground portion and a background portion in the image. The computing system additionally detects a first position 106 of eyes of the user 104 and generates the first composite image 102 based upon the detected first position 106 of the eyes of the user 104. With respect to the first composite image 102, the computing system positions the foreground portion relative to the background portion in the first composite image 102 based upon the detected first position 106 of the eyes of the user 104. More specifically, two objects are represented in the 2D image received by the computing system: a foreground object 108 and a background object 110. As can be seen in FIG. 1, when the computing system detects that the eyes of the user 104 who is viewing the display 100 is in the first position 106, the computing system generates the first composite image 102, where in the first composite image 102 the foreground object 108 partially obscures the background object 110.

With reference now to FIG. 2, another schematic view of the display 100 is shown, where an exemplary second composite image 103 is displayed on the display 100 when the user 104 is at a second position 112. In the example shown in FIG. 2, the computing system generates the second composite image 103 based upon the same 2D image used to generate the first composite image 102, where the second composite image 103 differs from the first composite image 102 due to a difference in position of eyes of the user 104. More specifically, the computing system detects that the eyes of the user 104 are in the second position 112 that is different from the first position 106. Due to the eyes of the user 104 being at the second position 112, the computing system generates the second composite image 103 such that the background object 110 is no longer obscured by the foreground object 108. Therefore, the positions of the foreground object 108 and the background object 110 relative to one another differ between the first composite image 102 and the second composite image due to the positions of the eyes of the user 104 being different. As will be described below, during a video conference, the computing system can present a sequence of composite images to a user, where the computing system positions foreground objects and background objects relative to one another in the composite images based upon video frames received by the computing system and detected positions of the eyes of the user, thereby providing a parallax effect.

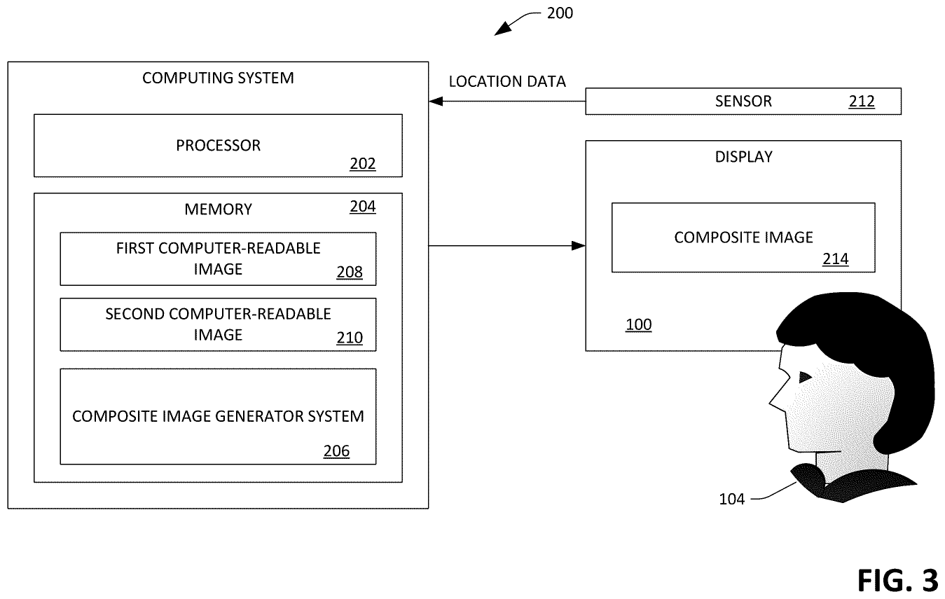

Referring now to FIG. 3, a functional block diagram of an exemplary computing system 200 is shown, where the computing system 200 is configured to generate composite images for display on the display 100 to be viewed by the user 104 viewing the display 100. The computing system 200 includes a processor 202 and memory 204, with the memory 204 including a composite image generator system 206 that is executed by the processor 202. The memory 204 also includes a first computer-readable image 208 and a second computer-readable image 210. As will be described in greater detail herein, the first computer-readable image 208 can be or include a first portion of an image and the second computer-readable image 210 can be or include a second portion of the image. More specifically, the first computer-readable image 208 can be a foreground portion of the image and the second computer-readable image 210 can be or include a background portion of the image. Accordingly, the first computer-readable image 208 can include a foreground object and the second computer-readable image can include a background object.

A sensor 212 and the display 100 are in (direct or indirect) communication with the computing system 200. The sensor 212 generates sensor data that can be processed to determine location of eyes of the user 104 relative to the sensor 212, and therefore relative to the display 100 (e.g., the sensor 212 is at a known location relative to the display 100). Thus, location data can be generated based upon output of the sensor 212. The composite image generator system 206 receives the location data generated based upon the sensor data output by the sensor 212. The sensor 212 can be any suitable type of sensor, where location of eyes of the user 104 can be detected based upon output of the sensor 212. For example, the sensor 212 can include a user-facing camera mounted on or built into the display 100 that generates image data that is processed through the computing system 114 or another computing system to detect the location of the eyes of the user 104 within image data. The composite image generator system 206 generates a composite image 214 based upon: 1) the first computer-readable image 208; 2) the second computer-readable image 210; and 3) the location data. The composite image 214 includes the first computer-readable image 208 and the second computer-readable image 210, where the first computer-readable image 208 is overlaid upon the second computer-readable image 210 in the composite image 214, and further where the composite image generator system 206 overlays the first computer-readable image 208 upon the second computer-readable image 210 at a position relative to the second computer-readable image 210 based upon the location data.

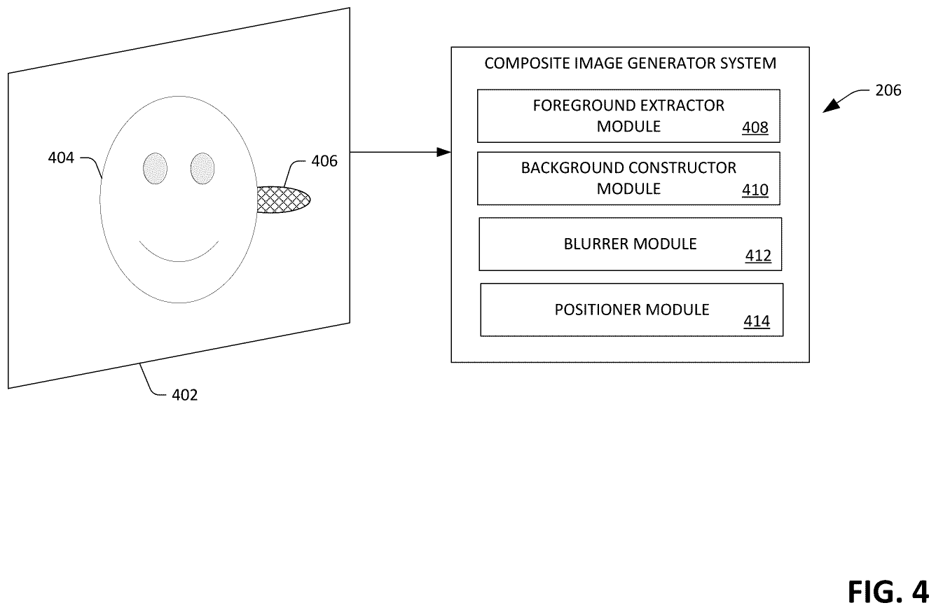

With reference now to FIG. 4, a functional block diagram of the composite image generator system 206 is shown. The composite image generator system 206 receives an image 402 that includes a foreground object 404 and a background object 406. As illustrated in FIG. 4, the foreground object 404 can be a face of a person (e.g., a person participating in a video conference) and the background object 406 can be any suitable object that is behind the person, such as a wall, a table, and so forth. Further, the background object 406 can be a virtual object, such as a virtual background used in videoconferencing scenarios. The composite image generator system 206 includes a foreground extractor module 408, a background constructor module 410, an optional blurring module 412, and a positioner module 414. The operation of the modules of the composite image generator system 206 are discussed in greater detail below.

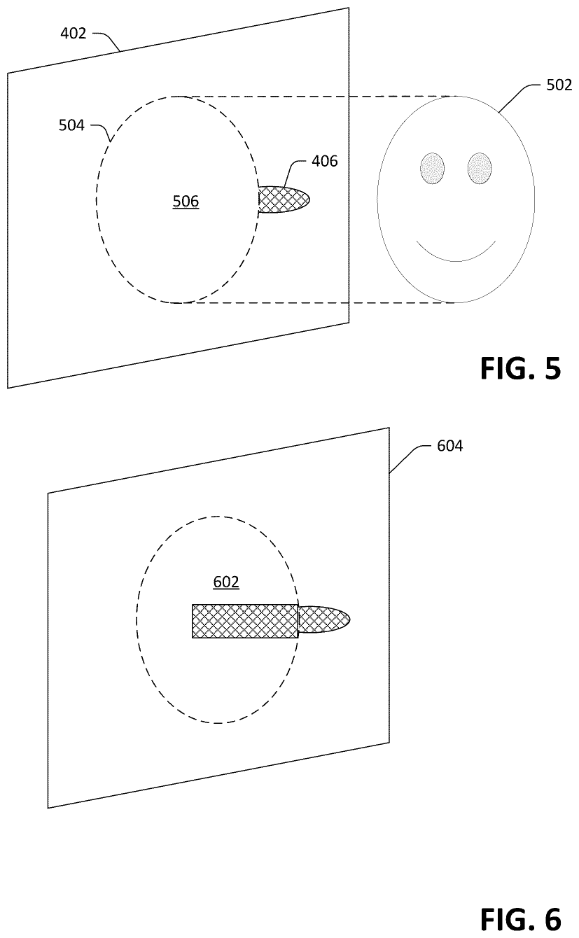

Referring to FIG. 5, a schematic that illustrates operation of the foreground extractor module 408 is presented. The foreground extractor module 408 extracts the foreground object 404 from the image 402 to create a foreground image 502. The foreground object 404 can be extracted from the image 108 by the foreground extractor module 408 through use of boundary detection technologies that detect a boundary 504 of the foreground object 404 (e.g., the face of a user) so that the foreground image 502 can be created from the pixels of the image 402 found within the boundary 504. The foreground extractor module 408 can utilize any suitable edge detection techniques and/or can incorporate a deep neural network that has been trained to detect a particular type of foreground object, such as, for example, the face of a user. The foreground extractor module 408 can also receive metadata along with the received image 402 to facilitate detection and extraction of the foreground object 404 from the image 402. For example, a depth map can be provided with the image 402 that is indicative of depths of the foreground object 404 and the background object 406, and the foreground extractor module 408 can extract the foreground object 404 from the image 402 based upon the depths. Additionally, a segmentation mask that identifies the foreground object 404 can be provided with the received image 402.

Extraction of the foreground object 404 from the image 402 leaves a void 506 in the image 402, wherein the background constructor module 410 is configured to populate the void to create a background image (e.g., the second computer-readable image 210) upon which the foreground image 502 can be overlaid.

With reference to FIG. 6, a schematic that illustrates operation of the background constructor module 410 is depicted. The background constructor module 410 operates to populate the void 506 in the image 402 left by the extraction of the foreground object 502 by generating a patch image 602 that is the same size and shape as the void 506. The background constructor module 410, upon populating the void 506 with the patch image 602, constructs a background image 604, where the background image 604 includes: 1) a portion of the background object 406 that was not occluded by the foreground object 404 in the image 402; and 2) the patch image 602.

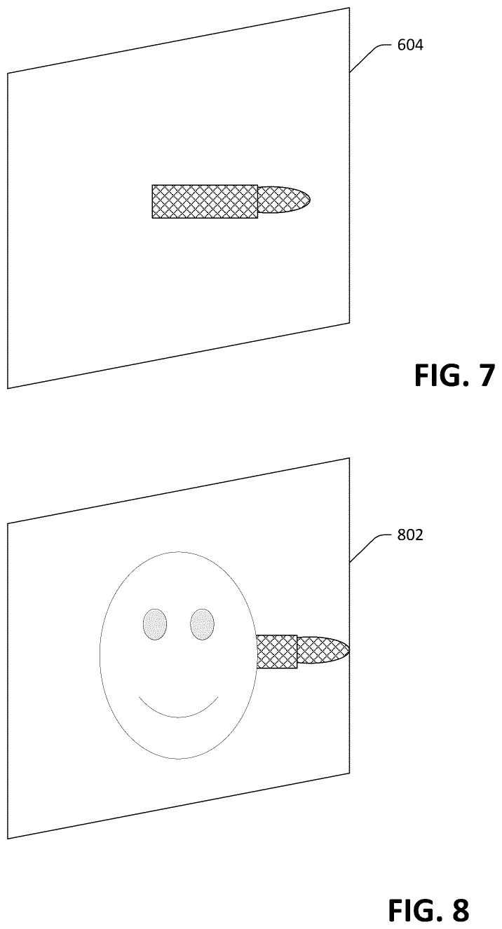

The background constructor module 410 can generate the patch image 602 through any suitable in-painting techniques. While the in-painted pixel values do not match a true background behind the foreground object 404, the values of the surrounding area are desirably close enough to produce a convincing effect. The patch image 602 can also be generated from observations as different portions of the background are exposed (e.g., due to the foreground object 404 being moved relative to the region in a scene behind the foreground object 404). Additionally, the background constructor module 410 can generate the patch image 602 from observations of the same or similar backgrounds on previous occasions, such as, for example, where the background is a home of a family member within which previous video calls have been conducted. Alternatively, a static or dynamic background image (optionally together with a depth map)—such as, for example, an image or video of an artificial background generated by a video conferencing application—can be provided along with the received image 402, and the background constructor module 410 can populate the void 406 with at least a portion of the background image 604. FIG. 7 is a schematic that depicts the background image 604 output by the background constructor module 410.

The blurrer module 412 can optionally blur the background image 604 either artificially or as a consequence of the depth of field of the lens of the camera (i.e., the so-called “bokeh” effect) used to generate the image 402. The blurrer module 412 receives the background image 604 and blurs the background image 604 to smooth the transition between the patch image 602 and the remainder of the background image 604.

FIG. 8 is a schematic that illustrates operation of the positioner module 414 to create a composite image 802. The positioner module 414 receives the foreground image 502, the background image 604, and the location data and generates the composite image 802. As can be seen in FIG. 8, the positioner module 414 has positioned the foreground image 502 relative to the background image 604 such that a portion of the patch image 602 is exposed in the composite image 802. For instance, the user 104 may be positioned towards the right-hand side of the display 100, and accordingly the positioner module 414 exposes more of the background to the right-hand side of the foreground object 404. The positioner module 414, for example, can position the foreground image 502 to be proximate to a center of the display 100 and shift the background image to the right (from the perspective of the user 104), thereby exposing a portion of the patch image 602. The amount of relative movement of the foreground image 502 and the background image 604 is inversely related to the estimated depth between the foreground object 404 and the background object 406; e.g., the greater the depth, the less relative movement between the foreground image 502 and the background image 604 as position of the eyes of the user 104 changes. It should also be noted that the positioning module 414 can operate on individual pixels based on a depth map received with the image 402 so that pixels move differently depending on their relative depth in the scene. Moreover, the composite image generator system 206 can generate several background images, one for each depth plane. The composite image generator system 206 can utilize any suitable technologies in connection with constructing different background images, including boundary detection, use of an infrared sensor to acquire depth data, etc.

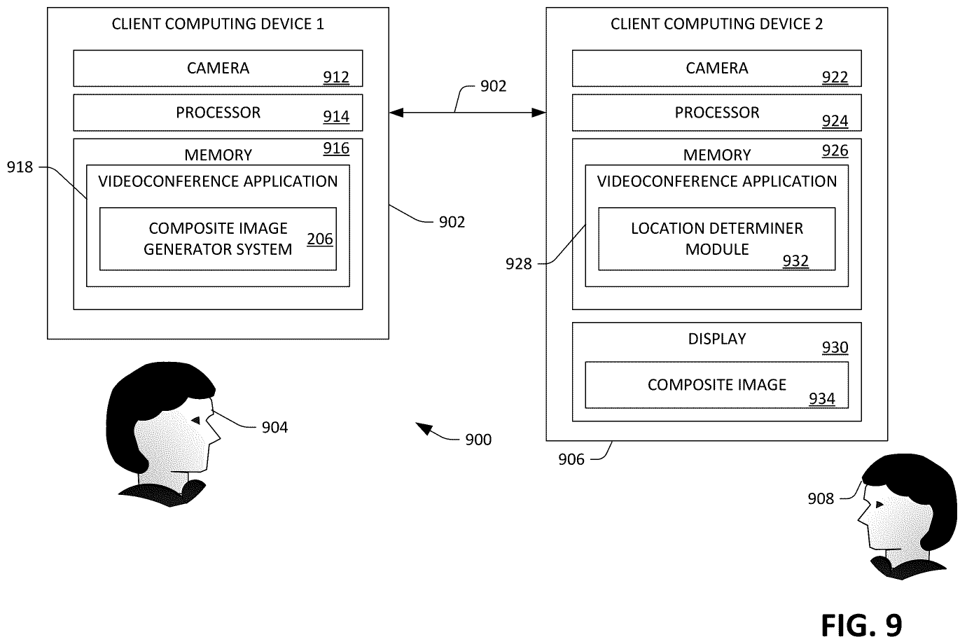

Referring now to FIG. 9, a functional block diagram of a computing environment 900 where two client computing devices are used by two users in a videoconferencing scenario is illustrated. The computing environment 900 includes a first client computing device 902 operated by a first user 904 and a second client computing device 906 operated by a second user 908. The first and second client computing devices 902 and 906 communicate with each other via a network connection 910.

The first client computing device 902 includes a camera 912, a processor 914, and memory 916. The memory 916 has a videoconferencing application 918 stored therein, where the videoconferencing application 918 is executed by the processor 914. The videoconferencing application 918 includes the composite image generator system 206.

The second client computing device 906 includes a camera 922, a processor 924, and memory 926. The memory 926 has a videoconferencing application 928 stored therein, where the videoconferencing application 928 is executed by the processor 924. The second client computing device 906 additionally includes a display 930. The videoconferencing application 928 includes a location determiner module 932 for determining the position of the eyes of the second user 908 relative to the display 930. The display 930 displays a composite image 934 generated by the composite image generator system 206 of the first client computing device 902.

During operation of first and second client computing devices 902 and 906 in the computing environment 900, the users 904 and 908 launch the videoconferencing applications 918 and 928 on their respective client computing devices 902 and 906. A connection between the videoconferencing applications 918 and 928 is established via the network connection 910 to facilitate the transmission of data between the videoconferencing applications 918 and 928. The camera 912 is directed towards and captures video of the first user 904 and the environment surrounding the first user 904. A video frame from the video is received by the composite image generator system 206 of the videoconferencing application 918. As is described herein, the composite image generator system 206 forms a composite image from two or more computer-readable images—e.g., the foreground and background of a video frame from the camera 212—where the relative position of the images is based on location data. Here, the location data is received from the second client computing device 906 by way of the network connection 910. The location data is generated from the location determiner module 932 of the videoconferencing application 928 that receives video frames of the second user 908 from the camera 922 and processes those video frames to determine the location of the head and/or eyes of the second user 908 relative to the display 930. The composite image 934 generated by the composite image generator system 220 is transmitted over the network connection 910 to be displayed on the display 930 of the second client computing device 906.

When a videoconference is in progress, the video frames captured by the cameras 912 and 922 are continuously processed by the videoconferencing applications 918 and 928. For example, the video frames captured by the camera 912 are processed by the video conferencing application 918 to create updated first and second images that are used to generate composite images. The video frames captured by the camera 922 are processed by the video conferencing application 928 to update the location of the user 908 relative to the display 930 that can be sent to the composite image generator system 206 of the first client computing device 902.

While the composite image generator system 206 and location determiner module 932 are each only shown in one of the client computing devices 902 and 906, the composite image generator system 906 and location determiner module 932 can be included in the videoconferencing applications 918 and 928 of both the first client computing device 902 and the second client computing system 906. In this arrangement, both users 904 and 906 can view images of the other user that include a simulated parallax effect. Further, while FIG. 9 depicts the composite image generator system 910 being executed on the “sender” side (e.g., the first client computing device 902, which generates and transmits composite images to the second client computing device 906), in another embodiment the composite image generator system 910 can be executed on the “receiver” side. In such an embodiment, the first client computing device 902 transmits video frames that include the face of the first user 904 to the second client computing device, and the composite image generator system 206 (executing on the second client computing device 906) receives the video frames and constructs composite images based upon the video frames (and the determined location of the eyes of the second user 908 relative to the display 930).

In addition, the composite image generator system 206 can enlarge or shrink foreground and background images based upon distance of the eyes of a user relative to a display. Therefore, as the user moves closer to the display, the foreground image and the background image can be enlarged, where such images can be enlarged at different rates of speed (with the foreground image being enlarged more quickly than the background image).

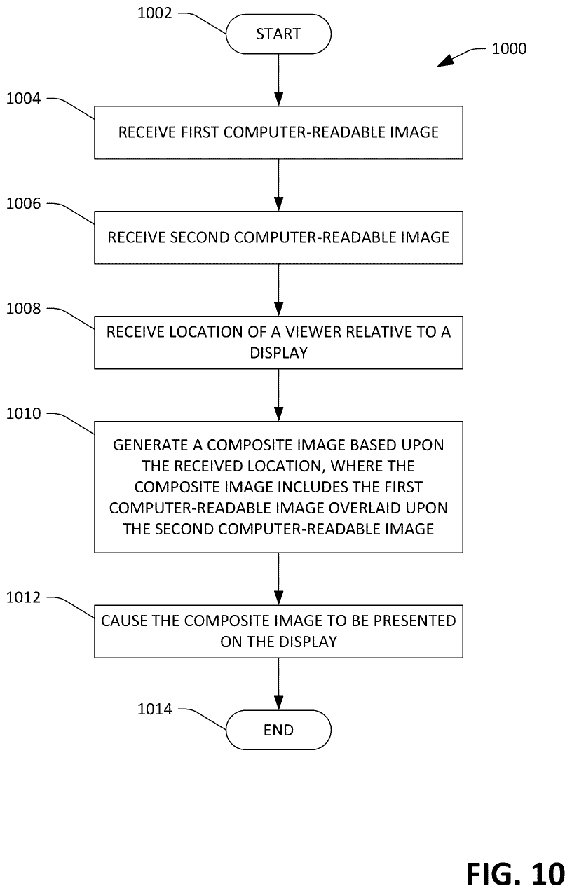

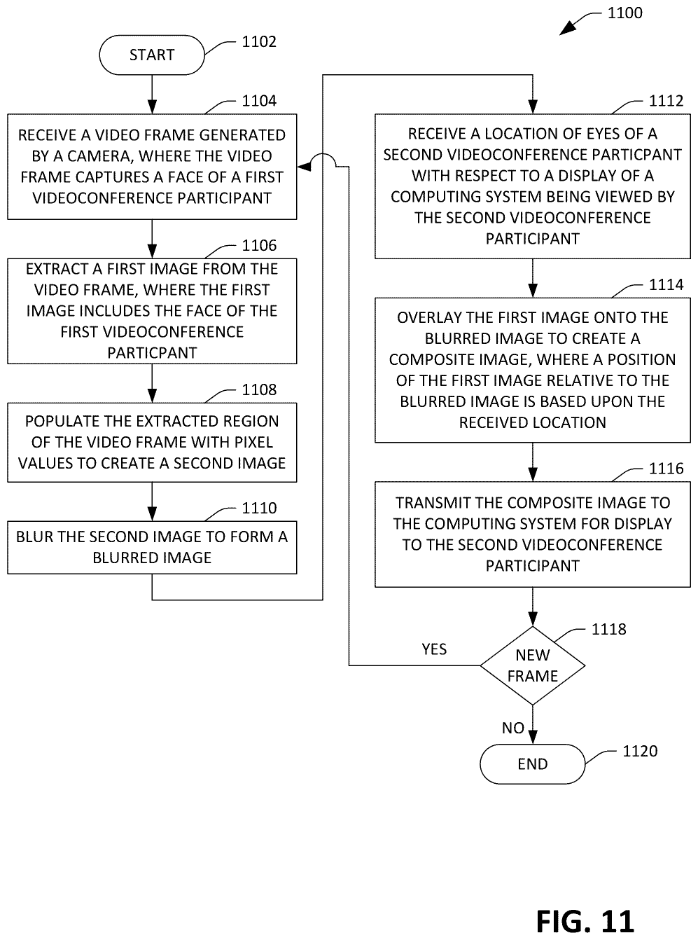

FIGS. 10 and 11 illustrate exemplary methodologies relating to the generation of a composite image to simulate a parallax effect based on the location of a viewer. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now solely to FIG. 10, a methodology 1000 that facilitates the generation of a parallax effect from a two-dimensional video source is illustrated. The methodology 1000 begins at 1002, and at 1004, a first computer-readable image is received, where the first computer-readable image includes a portion of a foreground of a scene. At 306, a second computer-readable image is received, where the second computer-readable image includes a portion of a background of the scene. At 1008, a location of a viewer relative to a display is received. At 1010, a composite image is generated based on the received location, where the composite image includes the first computer-readable image overlaid upon the second computer readable image. The position of the first computer-readable image relative to the second computer-readable image in the composite image is based upon the received location. The composite image is then caused to be displayed at 1012, and the methodology ends at 1014.

Referring now to FIG. 11, a methodology 1100 that facilitates the generation of a parallax effect in a videoconferencing environment is illustrated. The methodology 1100 beings at 1102, and at 1104 a video frame generated by a camera is received, where the video frame captures a face of a first videoconference participant. A first image is extracted from the video frame at 1106, where the first image includes the face of the first videoconference participant. The extracted region of the video frame is then populated with pixel values to generate a second image at 1108. And at 1110, the second image is blurred to form a blurred image.

At 1112, a location of eyes of a second videoconference participant with respect to a display of a computing system being viewed by the second videoconference participate is received. The received location is used at 1114 as a basis for a position of the first image relative to the blurred image when overlaying the first image onto the blurred image to create a composite image. At 1116, the composite image is transmitted to the computing system for display to the second videoconference participant. At 1118, a determination is made as to whether a new frame has bene received. When a new frame has been received, the methodology 1100 returns to 1104. When there are no new frames, the methodology 400 ends at 1120.

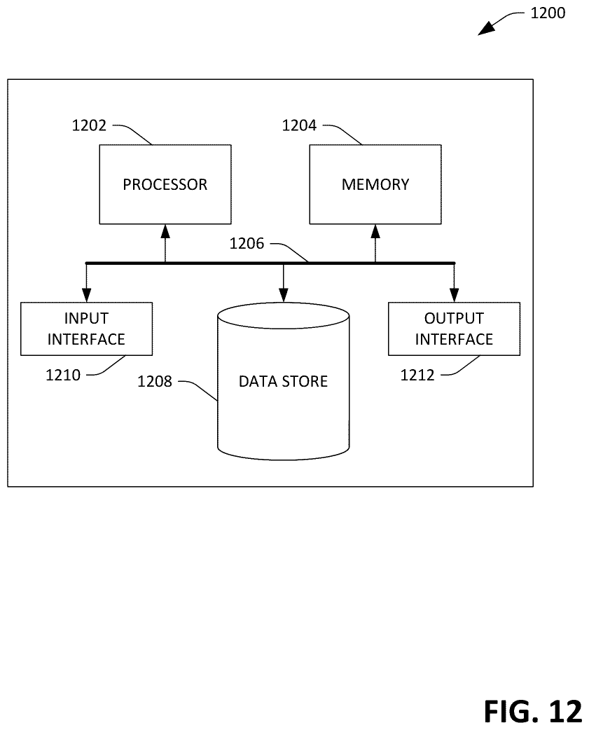

Referring now to FIG. 12, a high-level illustration of an exemplary computing device 1200 that can be used in accordance with the systems and methodologies disclosed herein is illustrated. For instance, the computing device 1200 may be used in a system that generates a composite image by overlaying a first computer readable image onto a second computer readable image, where the position of the first computer readable image relative to the second computer readable image is based on a location of a viewer relative to a display. By way of another example, the computing device 1200 can be one of a plurality of computing devices 1200 used to conduct videoconferencing calls between one or more of the plurality of computing devices 1200. The computing device 1200 includes at least one processor 1202 that executes instructions that are stored in a memory 1204. The instructions may be, for instance, instructions for implementing functionality described as being carried out by one or more components discussed above or instructions for implementing one or more of the methods described above. The processor 1202 may access the memory 1204 by way of a system bus 1206. In addition to storing executable instructions, the memory 1204 may also store a video conferencing application that includes a composite image generation system and a location determiner module.

The computing device 1200 additionally includes a data store 1208 that is accessible by the processor 1202 by way of the system bus 1206. The data store 1208 may include executable instructions, computer readable images, location data, etc. The computing device 1200 also includes an input interface 1210 that allows external devices to communicate with the computing device 1200. For instance, the input interface 1210 may be used to receive instructions from an external computer device, from a user, etc. The computing device 1200 also includes an output interface 1212 that interfaces the computing device 1200 with one or more external devices. For example, the computing device 1200 may display text, images, etc. by way of the output interface 1212.

It is contemplated that the external devices that communicate with the computing device 1200 via the input interface 1210 and the output interface 1212 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1200 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1200 may be a distributed system. Thus, for instance, several devices may be in communication by way of a network connection and may collectively perform tasks described as being performed by the computing device 1200.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Features have been described herein according to at least the following examples.

(A1) In one aspect, a method performed by a processor of a computing system is described, where the method includes receiving a first computer-readable image of a foreground of a scene and receiving a second computer-readable image of at least a portion of a background of the scene. The method also includes receiving location data, where the location data is indicative of a location of eyes of a viewer relative to a display. The method additionally includes generating a composite image based upon the first computer-readable image, the second computer-readable image, and the location data, where the composite image represents the scene, and further where generating the composite image includes overlaying the first computer-readable image upon the second computer-readable image and positioning the first computer-readable image relative to the second computer-readable image based upon the location data. The method also includes causing the composite image to be presented to the viewer on the display.

(A2) In some embodiments of the method of (A1), the method further includes generating the first computer-readable image. Generating the first computer-readable image includes receiving a video frame from a video feed generated by a camera of a computing device operated by a user, where the video frame captures a face of the user. Generating the first computer-readable image also includes identifying boundaries of the face of the user in the video frame and extracting the first computer-readable image from the video frame based upon the boundaries of the face of the user identified in the video frame, where the first computer-readable image includes the face of the user.

(A3) In some embodiments of the method of (A2), the method includes generating the second computer-readable image, where the second computer-readable image is generated subsequent to the first computer-readable image being extracted from the video frame.

(A4) In some embodiments of the method of (A3), extracting the first computer-readable image from the video frame creates void in the video frame, and further where generating the second computer-readable image comprises populating the void of the video frame with pixel values.

(A5) In some embodiments of the method of (A4), the pixel values are computed based upon values of pixels in the video frame.

(A6) In some embodiments of at least one of the methods of (A1)-(A5), the second computer-readable image is a static background image provided by a video conferencing application, and further where the first computer-readable image comprises a face of a person.

(A7) In some embodiments of at least one of the methods of (A1)-(A6), a computer-implemented video conferencing application comprises the instructions executed by the processor.

(B1) In another aspect, a method performed by a processor of a computing system is disclosed herein. The method includes receiving a first computer-readable image of a foreground of a scene. The method also includes receiving a second computer-readable image of at least a portion of a background of the scene. The method further includes receiving location data, where the location data is indicative of a location of eyes of a viewer relative to a display. The method additionally includes computing a position of the first computer-readable image relative to a position of the second computer-readable image based upon the location data. The method also includes overlaying the first computer-readable image upon the second computer-readable image at the computed position to form at least a portion of a composite image. The method additionally includes causing the composite image to be presented to the viewer on the display.

(B2) In some embodiment of the method of (B1), the method also includes generating the first computer-readable image, where generating the first computer-readable image includes: 1) receiving a video frame from a video feed generated by a camera of a computing device operated by a user, where the video frame captures a face of the user; 2) identifying boundaries of the face of the user in the video frame; and 3) extracting the first computer-readable image from the video frame based upon the boundaries of the face of the user identified in the video frame, wherein the first computer-readable image comprises the face of the user.

(B3) In some embodiments of the method of (B2), the method also includes generating the second computer-readable image, wherein the second computer-readable image is generated subsequent to the first computer-readable image being extracted from the video frame.

(B4) In some embodiments of the method of (B3), extracting the first computer-readable image from the video frame creates an empty region in the video frame, and generating the second computer-readable image includes populating the empty region of the video frame with pixel values.

(B5) In some embodiments of the method of (B4), the pixel values are computed based upon values of pixels in the video frame.

(B6) In some embodiments of at least one of the methods of (B1)-(B5), the second computer-readable image is a static background image provided by a video conferencing application, and further wherein the first computer-readable image comprises a face of a person.

(C1) In another aspect, a computing system that includes a processor and memory is described herein, where the memory stores instructions that, when executed by the processor, causes the processor to perform at least one of the methods disclosed herein (e.g., at least one of (A1)-(A7) or (B1)-(B6)).

(D1) In yet another aspect, a computer-readable storage medium includes instructions that, when executed by a processor, cause the processor to perform at least one of the methods disclosed herein (e.g., at least one of (A1)-(A7) or (B1)-(B6)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
receiving a first computer-readable image of a foreground of a scene;
receiving a second computer-readable image of at least a portion of a background of the scene;
receiving location data, wherein the location data is indicative of a location of eyes of a viewer relative to a display;
generating a composite image based upon the first computer-readable image, the second computer-readable image, and the location data, wherein the composite image represents the scene, and further wherein generating the composite image comprises:
overlaying the first computer-readable image upon the second computer-readable image; and
positioning the first computer-readable image relative to the second computer-readable image based upon the location data; and
causing the composite image to be presented to the viewer on the display.

2. The computing system of claim 1, the acts further comprising:
generating the first computer-readable image, wherein generating the first computer-readable image comprises:
receiving a video frame from a video feed generated by a camera of a computing device operated by a user, wherein the video frame captures a face of the user;
identifying boundaries of the face of the user in the video frame; and
extracting the first computer-readable image from the video frame based upon the boundaries of the face of the user identified in the video frame, wherein the first computer-readable image comprises the face of the user.

3. The computing system of claim 2, the acts further comprising:
generating the second computer-readable image, wherein the second computer-readable image is generated subsequent to the first computer-readable image being extracted from the video frame.

4. The computing system of claim 3, wherein extracting the first computer-readable image from the video frame creates void in the video frame, and further wherein generating the second computer-readable image comprises populating the void of the video frame with pixel values.

5. The computing system of claim 4, wherein the pixel values are computed based upon values of pixels in the video frame.

6. The computing system of claim 1, wherein the second computer-readable image is a static background image provided by a video conferencing application, and further wherein the first computer-readable image comprises a face of a person.

7. The computing system of claim 1, wherein a computer-implemented video conferencing application comprises the instructions executed by the processor.

8. A method performed by a processor of a computing system, the method comprising:
receiving a first computer-readable image of a foreground of a scene;
receiving a second computer-readable image of at least a portion of a background of the scene;
receiving location data, wherein the location data is indicative of a location of eyes of a viewer relative to a display;
computing a position of the first computer-readable image relative to a position of the second computer-readable image based upon the location data;
overlaying the first computer-readable image upon the second computer-readable image at the computed position to form at least a portion of a composite image; and
causing the composite image to be presented to the viewer on the display.

9. The method of claim 8, further comprising:
generating the first computer-readable image, wherein generating the first computer-readable image comprises:
receiving a video frame from a video feed generated by a camera of a computing device operated by a user, wherein the video frame captures a face of the user;
identifying boundaries of the face of the user in the video frame; and
extracting the first computer-readable image from the video frame based upon the boundaries of the face of the user identified in the video frame, wherein the first computer-readable image comprises the face of the user.

10. The method of claim 9, further comprising:
generating the second computer-readable image, wherein the second computer-readable image is generated subsequent to the first computer-readable image being extracted from the video frame.

11. The method of claim 10, wherein extracting the first computer-readable image from the video frame creates an empty region in the video frame, and further wherein generating the second computer-readable image comprises populating the empty region of the video frame with pixel values.

12. The method of claim 11, wherein the pixel values are computed based upon values of pixels in the video frame.

13. The method of claim 8, wherein the second computer-readable image is a static background image provided by a video conferencing application, and further wherein the first computer-readable image comprises a face of a person.

14. The method of claim 8, wherein a computer-implemented video conferencing application comprises the instructions executed by the processor.

15. A computer-readable storage medium comprising instructions that, when executed by a processor, cause the processor to perform acts comprising:
receiving a first computer-readable image of a foreground of a scene;
receiving a second computer-readable image of at least a portion of a background of the scene;
receiving location data, wherein the location data is indicative of a location of eyes of a viewer relative to a display;
generating a composite image based upon the first computer-readable image, the second computer-readable image, and the location data, wherein the composite image represents the scene, and further wherein generating the composite image comprises:
overlaying the first computer-readable image upon the second computer-readable image; and
positioning the first computer-readable image relative to the second computer-readable image based upon the location data; and
causing the composite image to be presented to the viewer on the display.

16. The computer-readable storage medium of claim 15, the acts further comprising:
generating the first computer-readable image, wherein generating the first computer-readable image comprises:
receiving a video frame from a video feed generated by a camera of a computing device operated by a user, wherein the video frame captures a face of the user;
identifying boundaries of the face of the user in the video frame; and
extracting the first computer-readable image from the video frame based upon the boundaries of the face of the user identified in the video frame, wherein the first computer-readable image comprises the face of the user.

17. The computer-readable storage medium of claim 16, the acts further comprising:
generating the second computer-readable image, wherein the second computer-readable image is generated subsequent to the first computer-readable image being extracted from the video frame.

18. The computer-readable storage medium of claim 17, wherein extracting the first computer-readable image from the video frame creates a void in the video frame, and further wherein generating the second computer-readable image comprises populating the void of the video frame with pixel values.

19. The computer-readable storage medium of claim 15, wherein the second computer-readable image is a static background image provided by a video conferencing application, and further wherein the first computer-readable image comprises a face of a person.

20. The computer-readable storage medium of claim 15, wherein the location of the eyes of the viewer are determined based upon an image of the user generated by a camera.
